(19) United States
(12) Patent Application Publication
(10) Pub. No.: US 2010/0230395 A1
(43) Pub. Date: Sep. 16, 2010

(54) WELDING TORCH

(75) Inventors: Yasushi Mukai, Osaka (JP); Toshiyuki Mishima, Osaka (JP)

Correspondence Address: Brinks Hofer Gilson & Lione/Panasonic, P.O. Box 10395, Chicago, IL, 60610, US

(73) Assignee: Matsushita Electric Industrial Co., Ltd., Kadoma-shi, Osaka (JP)

(21) Appl. No.: 12/294,560

(22) PCT Filed: Apr. 14, 2008
(86) PCT No.: PCT/JP2008/000966

§ 371 Date: Sep. 25, 2008

(30) Foreign Application Priority Data
Oct. 9, 2007 (JP) 2007-263102

(51) Int. Cl. B23K 9/26

(52) U.S. Cl. 219/136

(57) ABSTRACT

It comprises cylindrical feeder collet (6) formed with a slit portion at a front end thereof for feeding power to a welding wire internally set through; collet case (7) for storing feeder collet (6) therein, having an abutment on which the end of feeder collet (6) is abutted; flexible inner tube (4) for leading the welding wire to feeder collet (6); torch body (3) with inner tube (4) inserted therein and collet case (7) detachably disposed at the front end thereof; and spring (5) for pressurizing feeder collet (6) toward the front end of the welding wire, wherein there is provided a taper surface on at least any one of the front end of feeder collet (6) and the abutment of collet case (7). Thus, it is structurally simple and applicable for a curved torch.

### TECHNICAL FIELD

The present invention relates to a welding torch having a forced power feeder mechanism which is for example used for consumable electrode gas shield arc welding.

### BACKGROUND ART

A collet type forced power feeder structure is known as a forced power feeder mechanism (Patent document 1). This is a structure such that the power feeder is cylindrical and its inner diameter is nearly equal to the outer diameter of the welding wire (hereinafter called wire), and the cylindrical feeder is divided into a plurality of sections on a plane including the central axis or provided with a slit formed by slitting, and the inner diameter surface of the cylindrical feeder is pressed against the wire by an activating means.

The configuration and action of a welding torch having a collet type forced power feeder structure disclosed in Patent document 1 is briefly described in the following.

The cylindrical chip is formed with a through-hole as a passage for the wire that is a consumable electrode at the axial center thereof, and provided with conical projections at either end, and its end portion is at least halved by slitting. The cylindrical chip is disposed between the chip holder having a conical depression and a conical depression at the front end of the torch body detachable from the torch body base. The pressure means is formed by a spring support member disposed at the rear end of the torch body, of which the axial position can be freely set by a screw or the like, and a spring member disposed between the spring support member and the chip holder. The chip holder is pressed against the cylindrical chip by the pressure means, and a power feed member is connected to the torch body.

In the above configuration, the pressure generated by the pressure means is applied to both ends of the cylindrical chip and changed in direction to the centripetal direction due to the conical slopes at both ends, and thereby, the wire is always held by the conical chip. Accordingly, even in case the conical chip becomes worn, the wire is axially held and free from change of the wire position. Also, power feed to the wire is reliably executed at a constant position and it is possible to obtain an excellent welding result.

However, a conventional welding torch having a collet type forced power feeder structure as described above is actually hardly prevalent because of the following problems.

Particularly, as a welding torch used for robot welding, in order to cope with complicated jigs and work, a so-called curved torch with the torch body partially curved and improved in accessibility to the work or jig is widely employed. However, the method mentioned in Patent document 1 cannot be directly used for a curved torch.

And, when it is intended to use the method for a curved torch, a first idea is such that the pressure means is disposed not at the rear portion of the torch body but at the front end side beyond the curved portion of the torch body. However, the structure becomes complicated at the front end, and also, as pointed out in Patent document 1, the spring member that is a pressure means may deteriorate due to the influence of arc heat generated during the welding.

Also, in the case of the conventional welding torch described above, the inner diameter surface of the cylindrical chip gradually wears, and therefore, there is provided a through-hole nearly equal to the wire diameter in the initial condition, but in this case, the wire cannot be smoothly set through because it is caught at the rear end side of the cylindrical chip that is the wire insertion side.

Further, in the case of the conventional welding torch described above, when the cylindrical chip is divided into a plurality of sections by slitting, the inner diameter is displaced in the narrowing direction even in case of no pressure applied by the pressure means. Consequently, the wire cannot be set through, and it is necessary to completely remove the cylindrical chip or the chip body end portion holding the cylindrical chip before setting the wire. After that, the plurality of divided cylindrical chips must be individually abutted on the wire and must be set on the front end of the chip body while keeping them in a state of being held, resulting in considerable worsening of the workability.

On the other hand, when the cylindrical chip is halved instead of dividing into a plurality of portions, the pressure given by the pressure means is required to be high enough to be able to deform the cylindrical chip itself in accordance with wear of the cylindrical chip. Accordingly, in the initial condition of less wear, it is configured in that the axial position of the spring support member can be freely set by a screw or the like so that the pressure can be adjusted in accordance with wear of the cylindrical chip. However, it is very difficult to adjust the pressure in accordance with wear of the cylindrical chip that cannot be checked from outside, and it is almost impossible to make reliable adjustments at all times during the production.

Patent document 1: Unexamined Japanese Patent Publication H2-27074

### DISCLOSURE OF THE INVENTION

In order to solve the above problem, the welding torch of the present invention comprises a cylindrical feeder collet formed with a slit in the front end portion for feeding power to a welding wire internally set through; a collet case for storing the feeder collet therein, having an abutment on which the front end of the feeder collet is abutted; a flexible inner tube for leading the welding wire to the feeder collet; a torch body with the inner tube inserted therein and the collet case detachably disposed at the front end thereof; and a pressure mechanism for pressurizing the feeder collet toward the end of the welding wire, wherein there is provided a taper surface on at least any one of the front end of the feeder collet and the abutment of the collet case.

Thus, the feeder collet can be pressurized in the welding wire feeding direction by using the pressure means via the inner tube having flexibility (bending property), and thereby, the welding wire can be reliably held by the feeder collet. Accordingly, even in the case of a so-called curved torch of which the torch body of the welding torch is at least partially curved, it is possible to realize a forced feeder mechanism.

### BRIEF DESCRIPTION OF THE DRAWINGS

FIG. 1 is a schematic sectional view showing a welding torch in the preferred embodiment 1 of the present invention.

FIG. 2 is an enlarged sectional view showing a collet case in the preferred embodiment 1 of the present invention.

FIG. 3 is an enlarged sectional view showing an essential portion of a torch body in the preferred embodiment 1 of the present invention.

FIG. 4A is a top view of a feeder collet in the preferred embodiment 1 of the present invention.

FIG. 4B is a front view of a feeder collet in the preferred embodiment 1 of the present invention.

FIG. 4C is a bottom view of a feeder collet in the preferred embodiment 1 of the present invention.

FIG. 5 is an enlarged sectional view showing an essential portion of a torch body in the preferred embodiment 2 of the present invention.

FIG. 6 is an enlarged sectional view showing a collet case in the preferred embodiment 2 of the present invention.

### DESCRIPTION OF THE REFERENCE NUMERALS AND SIGNS

1 Torch cable

1a Torch body connection

1b, 3c Wire guide storing section

2 Conduit tube

3 Torch body

3a Torch cable connection

3b Collet case connection

4, 12 Inner tube

4a, 12a Wire guide connection

4b, 12b Conduit tube storing section

4c Coiled portion

5 Spring

6 Feeder collet

6a Taper surface

6b Slit portion

6c Feeding section

6d Wire insertion opening

7 Collet case

7a Insulative guide

7b Abutment

8 Insulating cylinder

9 Orifice

10 Nozzle

11 Wire

100 Welding torch

### DETAILED DESCRIPTION OF THE PREFERRED EMBODIMENTS

### Preferred Embodiment 1

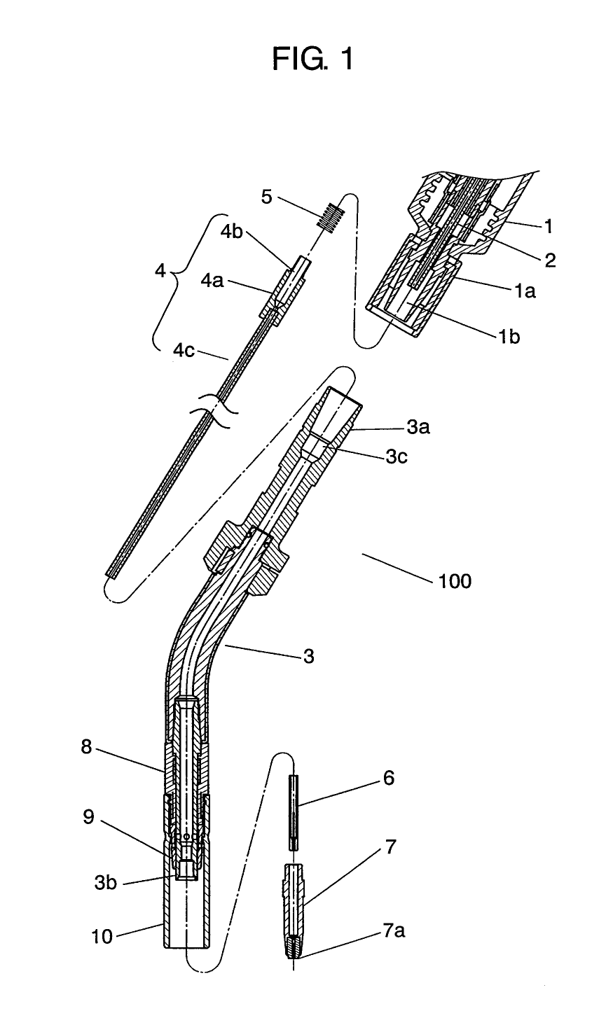

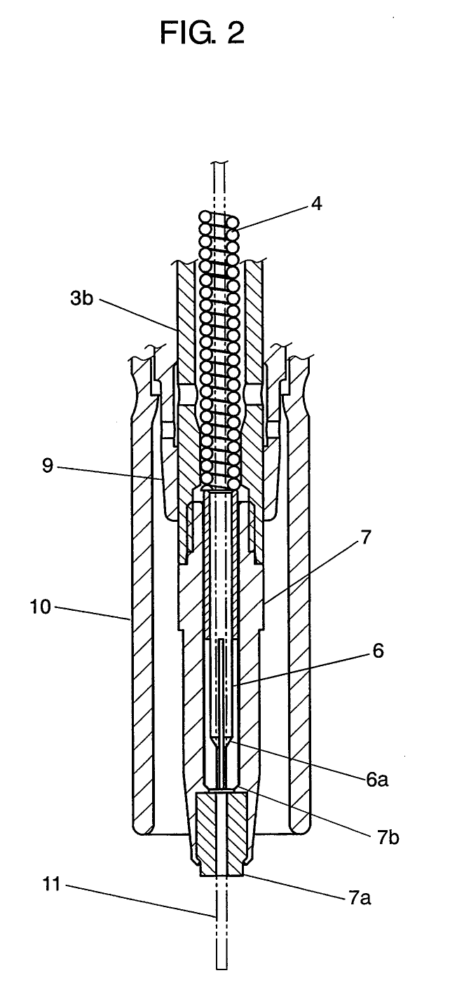

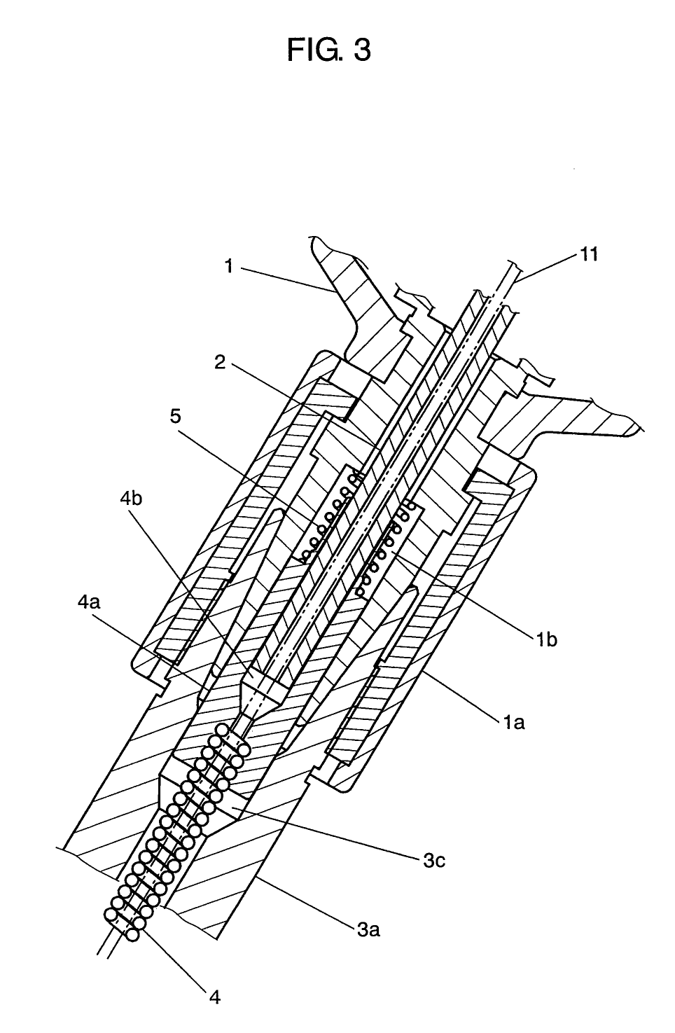

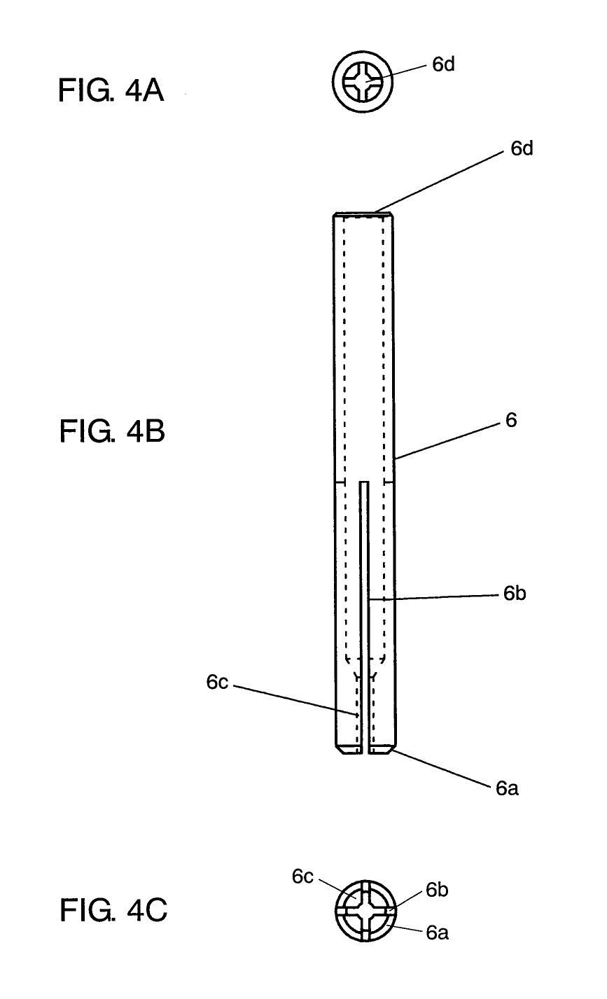

The preferred embodiments of the present invention will be described in the following with reference to FIG. 1 to FIG. 4. FIG. 1 is a schematic sectional view showing a welding torch in the present preferred embodiment. FIG. 2 is an enlarged sectional view showing a collet case and its surrounding in the present preferred embodiment. FIG. 3 is an enlarged sectional view showing an essential portion of a torch body and its surrounding in the present preferred embodiment. FIG. 4A to FIG. 4C respectively show the top view, front view, and bottom view of a feeder collet in the present preferred embodiment.

In FIG. 1 to FIG. 4C, torch cable 1 is fitted to a wire feeding device (not shown) at the rear end (not shown) thereof. Torch cable 1 is provided with a hole for axially inserting welding wire 11 (hereinafter called wire, see FIG. 2). Also, at the front end portion of torch cable 1, there is provided torch body connection 1a for detachably connecting torch body 3. And, torch body connection 1a is internally provided with wire guide storing section 1b that is a space for storing wire guide connection 4a described later in such a manner as to be slidable in the axial direction.

Torch body 3 of welding torch 100 is partially curved as shown in FIG. 1, and is detachably connected to torch body connection 1a of torch cable 1 by means of torch cable connection 3a disposed at the rear end portion. For example, torch body connection 1a is a box nut, and torch cable connection 3a is realized as a screw portion threadedly engaging the box nut that is torch body connection 1a. Further, torch body 3 is provided with wire guide storing section 3c that is a space for storing wire guide connection 4a in torch cable connection 3a in such a manner as to be slidable in the axial direction. Also, torch body 3 is provided with a hole for inserting inner tube 4 described later along the central axis of torch body 3. Further, at the front end portion of torch body 3, there is provided collet case connection 3b for detachably connecting collet case 7 described later. Also insulating cylinder 8 is disposed at the front end side of torch body 3, and nozzle 10 is disposed at the front end side of insulating cylinder 8. Nozzle 10 is internally provided with orifice 9.

Collet case 7 is cylindrical, and it is detachably connected to collet case connection 3b of torch body 3 at the rear end thereof. For example, collect case 7 and torch body 3 are threadedly engaged and securely connected to each other. Feeder collet 6 is stored in collet case 7 in such a manner as to be slidable in the axial direction, and it is provided with tapered abutment 7b on which the front end of feeder collet 6 is abutted (see FIG. 2). At the front end of collet case 7, there is provided insulative guide 7a made of insulating ceramic having a wire insertion hole a little larger than the outer diameter of wire 11.

Feeder collet 6 is provided with taper surface 6a at the end thereof as shown in FIG. 4A to FIG. 4C. Also, at the end (a part in the wire feeding direction) of feeder collet 6, there is provided feeding section 6c for feeding power to wire 11, coming in contact with wire 11, of which the inner diameter is nearly equal to the outer diameter of wire 11. Further, at the rear end (other than the front end portion) of feeder collet 6, there is provided wire insertion opening 6d of which the inner diameter is larger than the inner diameter at front end portion. Also, feeder collet 6 is provided with at least one slit portion 6b by forming a long slit longer in length than feeding section 6c in the axial direction from the tip thereof.

Inner tube 4 described above is a member that is also called a liner or neck liner. Inner tube 4 has coiled portion 4c with a wire material having a circular section spirally wound thereon as shown in FIG. 1, which has flexibility (bending property) to go along the curved shape of torch body 3. And, it is inserted from torch cable connection 3a side with respect to torch body 3, and the end of inner tube 4 is abutted on the rear end of feeder collet 6. Further, inner tube 4 internally includes conduit tube storing section 4b that is a space for storing conduit tube 2 of torch cable 1 in such a manner as to be slidable in the axial direction. Also, the length of inner tube 4 is adjusted so that wire guide connection 4a disposed at the rear end is not abutted on the bottom of each of wire guide storing section 1b of torch cable 1 and wire guide storing section 3c of torch body 3. Inner tube 4 is preferable to be a tube-like flexible member having wire guide connection 4a instead of the one with a wire material having a circular section spirally wound thereon.

Spring 5 is a spring member as a pressure mechanism formed of a compression spring, and its one end is fixed on the rear end of wire guide connection 4a. And, the other end of spring 5 is abutted on the bottom of wire guide storing section 1b. In this way, inner tube 4 and feeder collet 6 are pressurized in the feeding direction of wire 11.

Conduit tube 2 is inserted from the rear end (not shown) of torch cable 1, and the length is adjusted so that the front end is not abutted on the bottom of conduit tube storing section 4b of inner tube 4.

The operation of welding torch 100 having the above configuration will be described in the following.

Wire 11 is fed by a wire feeding device (not shown), and is guided to conduit tube 2 at the axial center of torch cable 1 and inner tube 4 of welding torch 100. And, it is inserted into wire insertion opening 6d (see FIG. 4B) of feeder collet 6 and passes through feeding section 6c (see FIG. 4B), then it is ejected from the tip end of insulative guide 7a of collet case 7, passing there through. In this case, feeder collet 6 is pressed in the feeding direction of wire 11 by the pressure applied by spring 5 being compressed via inner tube 4. Due to the pressure, taper surface 6a of feeder collet 6 abutting taper-like abutment 7b disposed in collet case 7 acts to deform slit portion 6b in the centripetal direction, and thereby, wire 11 is held with the inner diameter surface of feeding section 6c. In this way, the welding power supplied from the welding power supply device (not shown) is reliably fed to wire 11 from feeding section 6c contacted thereon by the pressure via torch cable 1 and torch body 3.

As described above, according to the present preferred embodiment, collet feeder 6 can be pressurized by spring 5 that is a pressure means via inner tube 4 having flexibility (bending property). As a result, it is possible to realize a forced power feeder mechanism even in the case of a so-called curved torch wherein torch body 3 is at least partially curved.

Also, spring 5 that provides a pressure is disposed in a position sufficiently apart from the front end of welding torch 100, and therefore, it is free from the influence of arc heat generated during the welding and there is no fear of its deterioration caused due to such arc heat.

Further, since inner tube 4 is coil-formed with a wire material having a circular section spirally wound thereon, it is possible to realize inexpensive inner tube 4 which is flexible in the radial direction.

Also, spring 5 is disposed in a space formed at the connection between torch body 3 and torch cable 1. Accordingly, torch body 3 and torch cable 1 can be easily disconnected from each other by torch body connection 1a and torch cable connection 3a. As a result, it is easy to perform the maintenance such as replacement of spring 5.

Further, the inner diameter of the front end portion of feeder collet 6, which serves as feeding section 6c, is nearly equal to the diameter of wire 11, and the inner diameter of the rear end portion serving as wire insertion opening 6d is larger than the inner diameter of the front end portion. In this way, wire 11 can be easily set through feeder collet 6, and it is possible to realize a welding torch having a forced power feeder mechanism which may assure excellent workability.

Also, the slit length of slit portion 6b of feeder collet 6 is longer than the length of feeding section 6c whose inner diameter of the front end portion is nearly equal to the diameter of wire 11, and it is possible to realize feeder collet 6 being less in drag on deformation. Accordingly, there is less resistance to feeding of wire 11, and it is possible to realize a welding torch having a forced power feeder mechanism for which it is not necessary to adjust the pressure in accordance with wear of feeder collet 6.

Further, wire 11 is guided, and also, for protecting feeder collet 6 from spatter, insulative guide 7a made of insulating ceramic which is provided with wire insertion hole a little larger than the wire diameter is disposed at the front end of collet case 7. In this way, feeder collet 6 can be prevented from damage due to spatter, and it is possible to prevent the occurrence of power feed to wire 11 at a place other than the pertinent feeding section due to sticking of spatter. Accordingly, it is possible to realize a welding torch having a forced power feeder mechanism which may assure a long life and stable operation.

In the present preferred embodiment, abutment 7b of collet case 7 and taper surface 6a of feeder collet 6 are tapered as described. However, the present invention is not limited to this configuration, and it is also preferable to make one of them tapered because only needed is to deform slit portion 6b of feeder collet 6 in the centripetal direction.

Also, in the present preferred embodiment, inner tube 4 is coil-formed with a wire material having a circular section spirally wound thereon as described, but it is also allowable to be cylindrical instead of being coil-formed.

Further, in the present preferred embodiment, spring 5 is used as a pressure mechanism as described, but it is also preferable to use, in place of spring 5, an elastic member having elasticity in the feeding direction of wire 11, which internally allows the insertion of conduit tube 2.

### Preferred Embodiment 2

In this preferred embodiment, the same configuration as in the preferred embodiment 1 is given same reference numeral, and the detailed description is omitted. This preferred embodiment differs from the preferred embodiment 1 in such point that instead of applying a pressure to feeder collet 6 by means of inner tube 4 and spring 5 in the preferred embodiment 1, a pressure is applied to feeder collet 6 by means of inner tube 12 having elasticity without using spring 5.

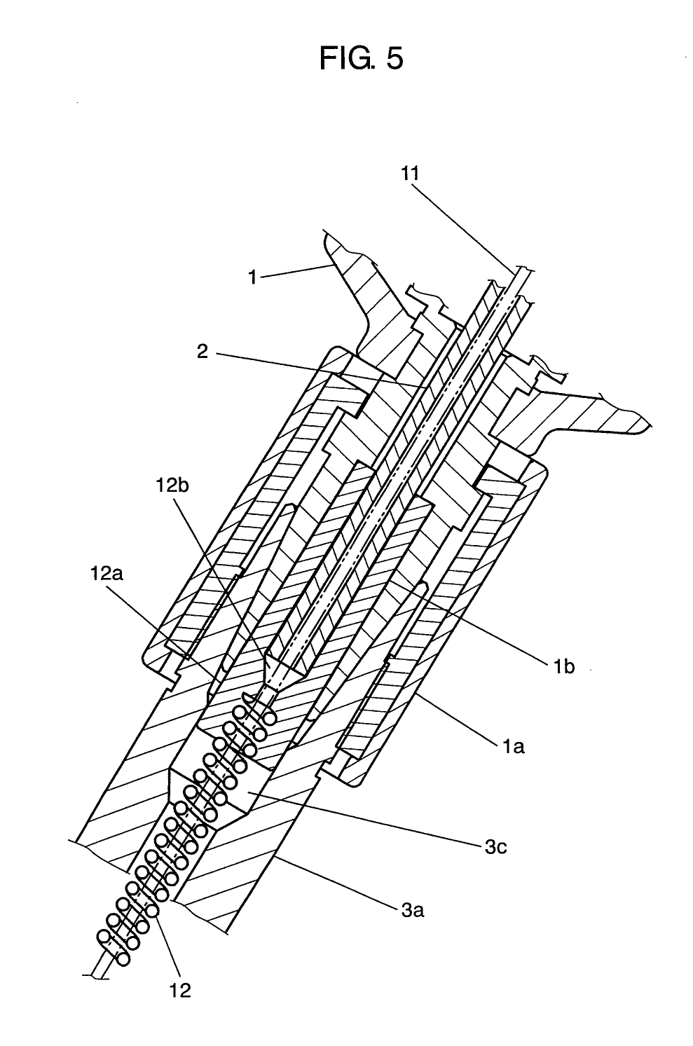

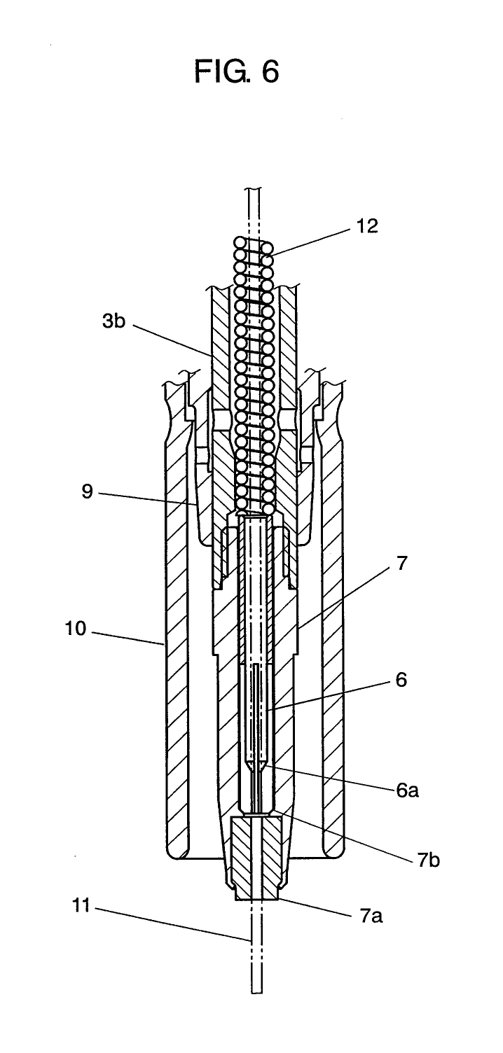

FIG. 5 is an enlarged view showing an essential portion of a torch body in the present preferred embodiment. FIG. 6 is an enlarged view showing a collet case in the present preferred embodiment. In FIG. 5 and FIG. 6, inner tube 12 is coil-formed having compressive elasticity in the axial direction (lengthwise direction), which is formed with a wire material having a circular section spacedly spirally wound thereon. And, the same as in the preferred embodiment 1, it has flexibility (bending property) to go along the curved shape of torch body 3. Further, inner tube 12 is inserted into the torch body (not shown) from torch cable connection 3a side, and the front end of inner tube 12 abuts the rear end of feeder collet 6. On the other hand, the rear end of inner tube 12 has conduit tube storing section 12b for storing conduit tube 2 therein in such manner as to be slidable in the axial direction. Further, wire guide connection 12a disposed at the rear end of inner tube 12 abuts the bottom of wire guide storing section 1b of torch cable 1. In this way, the rear end of inner tube 12 having elasticity abuts wire guide storing section 1b, and the front end thereof abuts the feeder collet, and thereby, feeder collet 6 is pressurized forward in the axial direction. Inner tube 12 is preferable to have a length enough to be compressed when torch body 3 and torch cable 1 are connected to each other.

The operation of the welding torch having the above configuration will be described in the following. Wire 11 is fed by a wire feeding device (not shown), and is guided to conduit tube 2 at the axial center of torch cable 1 and inner tube 12 in welding torch 100. And, as shown in FIG. 4B, it is inserted into wire insertion opening 6d of feeder collet 6 and passes through feeding section 6c, then it is ejected from the end of insulative guide 7a disposed in collet case 7, passing there through.

In this case, feeder collet 6 is pressed forward in the axial direction by the pressure of inner tube 12 being compressed, and comes in contact with tapered abutment 7b disposed in collet case 7. Consequently, slit portion 6b (see FIG. 4B) is deformed in the centripetal direction due to taper surface 6a (see FIG. 4B) of feeder collet 6, and thereby, wire 11 is held with the inner diameter surface of feeding section 6c (see FIG. 4B). The welding power supplied from the welding power supply (not shown) is reliably fed to wire 11 from feeding section 6c held thereon with the pressure via torch cable 1, torch body 3, and collet case 7.

As described above, according to the present preferred embodiment, collet feeder 6 can be pressurized inner tube 12 having flexibility (bending property) and elasticity in the lengthwise direction. As a result, it is possible to realize a forced power feeder mechanism even in the case of a so-called curved torch wherein torch body 3 is at least partially curved.

Also, inner tube 12 is coil-formed with a wire material having a circular section spirally wound thereon and is provided with a pressing function as a pressure mechanism, and therefore, it requires no separate pressure mechanism. Accordingly, it is possible to realize an inexpensive forced power feeder mechanism.

Further, in the present preferred embodiment, inner tube 12 is coil-formed with a wire material having a circular section spirally wound thereon as described, but the tube is also allowable to be cylindrical instead of being coil-formed provided that it is elastic.

In the preferred embodiments 1 and 2 described above, spring 5 is used as a pressure mechanism in the preferred embodiment 1, and inner tube 12 having elasticity is used as a pressure mechanism in the preferred embodiment 2. However, it is also preferable to use both of spring 5 and inner tube 12 having elasticity as a pressure mechanism in the configuration.

### INDUSTRIAL APPLICABILITY

The present invention is excellent in accessibility to the work and jigs as a curved torch, which also ensures low costs, excellent workability and easy maintenance. In addition, it comprises a forced power feeder mechanism that may assure a long life and stable operation, which is industrially useful as a welding torch having a forced power feeder mechanism.

1. A welding torch comprising:
a cylindrical feeder collet formed with a slit axially extending from a front end thereof for feeding power to a welding wire internally set through;
a collet case for storing the feeder collet therein, having an abutment on which the front end of the feeder collet is abutted;
a flexible inner tube for leading the welding wire to the feeder collet;
a torch body with the inner tube inserted therein and the collet case detachably disposed at the front end thereof; and
a pressure mechanism for pressurizing the feeder collet toward the end of the welding wire,
wherein there is provided a taper surface on at least any one of the front end of the feeder collet and the abutment of the collet case.

2. The welding torch of claim 1, wherein the torch body is partially curved.

3. The welding torch of claim 1, wherein the inner tube is coil-formed with a wire material having a circular section spirally wound thereon.

4. The welding torch of claim 1, wherein the inner tube has lengthwise elasticity, and the pressure mechanism uses elasticity of the inner tube.

5. The welding torch of claim 1, wherein the pressure mechanism is formed of an elastic member disposed at the rear end of the inner tube.

6. The welding torch of claim 1, wherein the torch body includes a torch body connection disposed at the front end of a torch cable for feeding the welding wire and a torch cable connection detachably disposed at a rear end thereof;
the inner tube includes a front end of a conduit tube for setting the torch cable through and a wire guide connection detachably disposed at the rear end thereof; and
the pressure mechanism is formed of a spring member whose one end abuts the torch body connection and the other end abuts the wire guide connection.

7. The welding torch of claim 6, wherein the spring member is fixed on the wire guide connection.

8. The welding torch of claim 1, wherein the front end of the feeder collet is provided with a feeding section for feeding power to the welding wire, and the inner diameter of the feeding section is equal to the diameter of the welding wire, and the inner diameter of the rear end portion of the feeder collet is larger than the diameter of the welding wire.

9. The welding torch of claim 8, wherein the length of the slit portion is longer than the length of the feeding section.

10. The welding torch of claim 1, wherein the collet case has an insulative guide at the front end thereof which has a diameter larger than the diameter of the welding wire.

11. The welding torch of claim 2, wherein the inner tube is flexible and bends along a curved shape of the torch body.
